(19) United States
(12) Patent Application Publication
(10) Pub. No.: US 2025/0095255 A1
(43) Pub. Date: Mar. 20, 2025

(54) SYSTEMS AND METHODS FOR MEDICAL IMAGE PROCESSING

(71) Applicant: Siemens Healthineers AG, Forchheim (DE)

(72) Inventors: Lars BOHN, Neunkirchen am Brand (DE); Felix DINGELDEY, Erlangen (DE)

(73) Assignee: Siemens Healthineers AG, Forchheim (DE)

(21) Appl. No.: 18/883,457

(22) Filed: Sep. 12, 2024

(30) Foreign Application Priority Data
Sep. 15, 2023 (DE) 10 2023 208 957.2

(51) Int. Cl. G06T 11/60; G06T 3/40; G06T 7/70; G06T 11/20; G06V 10/25

(52) U.S. Cl. CPC G06T 11/60; G06T 3/40; G06T 7/70; G06T 11/203; G06V 10/25; G06T 2207/10088; G06T 2207/10104; G06T 2207/10116; G06T 2207/10132; G06T 2207/20104; G06T 2207/30004; G06T 2210/41; G06T 2210/62; G06V 2201/03

(57) ABSTRACT

One or more example embodiments relates to a processing of medical images when a medical image is provided together with at least one annotational data element. A region of interest is identified, which is currently relevant for a user. After identifying such a region of interest, which may be done dynamically or continuously, the at least one annotational data element is provided with an appearance so that the region of interest is obscured as less as possible.

### CROSS-REFERENCE TO RELATED APPLICATION(S)

The present application claims priority under 35 U.S.C. § 119 to Germany Patent Application No. 10 2023 208 957.2, filed Sep. 15, 2023, the entire contents of which is incorporated herein by reference.

### FIELD

One or more example embodiments relates to a method and an apparatus for processing a medical image. In particular, one or more example embodiments relates to a processing of the medical image for outputting the medical image in common with one or more annotational data elements.

### RELATED ART

In the context of medical examinations, imaging methods have become very important. Such imaging methods may comprise, for example, ultrasonic images, radiological images, especially images from a computer tomograph or a magnetic resonance tomograph. After capturing one or more images of an examination area of a patient, the images are analyzed and documented by a medical specialist, e.g. a radiologist. For this purpose, the medical specialist usually adds additional information, e.g. in the form of annotations, notes, markings, labels, symbols and/or any other kind of further information to the captured image. Further, additional information, such as patient information, e.g. name, date of birth, information about place and/or time, when the image was recorded, information about the device and the applied setting(s) used for capturing the image and/or reasons for the related medical examination (e.g. medical question) may be also provided in association with a captured medical image. If this additional information is displayed together with the image, it is therefore possible that some of the details in the image are obscured by the representation of the additional information. If, on the other hand, the additional information is completely hidden or fade out, a user may no longer have access to information that could possibly be important.

### SUMMARY

It is therefore a need for a way to process medical data in the context of medical images in a manner such that the medical image is output together with additional information in a way which makes it possible that no information is lost. In particular, a user should be able to grasp many details of a relevant position in the image and at the same time the user is provided with as many additional information as possible. In particular, there is a need for providing a medical image and related additional information in a manner which allows a dynamical adjustment of the output for the medical image and the related additional information in view of the needs and requirements of the present application.

One or more example embodiments therefore provides a method and an apparatus for processing medical images and a computer program with the features of the independent claims. Further advantageous embodiments are subject matter of the dependent claims.

### BRIEF DESCRIPTION OF THE DRAWINGS

In the following detailed description of the figures, non-limiting exemplary embodiments with the features and further advantages thereof will be discussed with reference to the drawings. In the figures:

FIG. 1: a schematic illustration of a representation comprising a medical image and further annotational data elements according to one or more example embodiments;

FIG. 2: a schematic block diagram illustrating an apparatus for processing a medical image according to an embodiment;

FIG. 3: a flowchart of a method for processing a medical image according to an embodiment; and

FIGS. 4-9: schematic illustrations of possible modifications of an appearance for annotational data elements according to one or more example embodiments.

### DETAILED DESCRIPTION

According to a first aspect, a method for processing a medical image is provided. The method comprises a step of receiving a medical image. The image may be received in any appropriate manner and format. For example, the medical image may be directly received from a medical imaging device. Alternatively, the medical image may be received from a local or remote storage device. The method further comprises a step of determining at least one annotational data element. The annotational data element is to be displayed in common with the received medical image. In particular, the annotational data element is related to the medical image or parts thereof. Further, the method comprises a step of determining a region of interest in the received medical image. The region of interest may be a position or an area of particular interest for a user. The determination of the region of interest may be performed manually based on an indication of the user or automatically, e.g., by analyzing the user's activities. The method further comprises a step of calculating an appearance of the at least one annotational data element. The appearance may be computed in reply to the determined region of interest. As will be explained in more detail below, the appearance may relate to a position for providing the respective annotational data element and/or a visual effect, e.g., automatically, applied to the annotational data element. Finally, the method comprises a step of outputting the calculated appearance of the at least one annotational data element in common with the medical image. For this purpose, an output device may be used. The medical image and the calculated appearance of the at least one annotational data element may be output in any appropriate manner, for instance, by displaying on a computer screen or on a display to be used in an interventional procedure.

According to a second aspect, an apparatus for processing a medical image is provided. The apparatus may be configured for executing the method according to the first aspect.

The apparatus may comprise a reception interface, an annotational unit, a processing unit and an output interface. The reception interface is configured for receiving a medical image for processing the medical image. The annotational unit is configured for determining at least one annotational data element. The annotational data element may be displayed in common with the received medical image. Further, the annotational data element may relate to the medical image or parts thereof. The processing unit is configured for determining a region of interest in the received medical image. The processing unit is further configured for calculating an appearance of the at least one annotational data element in reply to the determined region of interest. The output interface is configured for outputting the calculated appearance of the at least one annotational data element in common with the medical image.

According to a third aspect, a computer program is provided. The computer program may be loadable into a memory unit of a computing unit, including program code sections to make the computing unit execute the method for processing a medical image according to the first aspect, when the computer program is executed in the computing unit.

A medical image within the meaning of the present invention may be an image that could be used for medical purposes. For example, a medical image may be used for diagnostic purposes of a living being, in particular a human being or an animal. The medical image may provide, for example, a two-dimensional representation of a body or a part of the body. For example, the medical image may be obtained from an ultrasonic imaging modality, an X-ray imaging modality or any other kind of imaging system which can be used for obtaining images for a medical purpose. The medical image may be directly obtained from a modality acquiring the medical images or the medical image may be obtained from a storage device for storing data of medical images. The medical image may represent a whole body of a living being, a part of a living being, for example an arm, a leg, an organ, a structure within the living being such as an implant or stent, etc. In particular, the medical image may be a two-dimensional representation which can be derived, for example, from a two- or three-dimensional dataset. Such a three-dimensional dataset may be obtained, for example via a computer tomograph, a positron emission tomography apparatus or a magnetic resonance tomograph. The data of a medical image which may be used in one or more example embodiments may be provided in any appropriate data structure. For example, the medical image may be received according to a DICOM-Standard. However, any other appropriate format such as TIFF, JPG or the like may be possible, too.

For receiving the medical image, a reception interface may be used. The reception interface may be communicatively coupled with a data source for providing medical images. A data source may be, for example an imaging device such as an ultrasonic modality or an X-ray modality. Alternatively, the medical image may be received from a storage device such as a local storage, e.g. a hard disk, a network storage, a cloud service and/or any other appropriate storage for storing and providing image data.

In particular, the medical image may be received for processing the medical image. This further processing (operation) may comprise, for example, annotating, analysing, reporting, a documentation and/or a comparison of the image with further medical images such as similar images acquired at a different point in time, etc.

Annotational data elements in the context of one or more example embodiments may be data elements which may be provided and/or displayed together with the medical image. Annotational data elements may provide additional information in connection with the medical image. In particular, annotational data elements may comprise additional information.

For example, annotational data elements may provide information about the patient to which the medical image relates to, information about the organisation and/or the location where the medical image has been acquired, information about the device, in particular the configuration of the device which has been used for acquiring the medical image, timestamp information or any other technical information.

The annotational data elements may relate to an indication for a specific position or region within the medical image. For example, the annotational data element may comprise an arrow, a cross or any other kind of marker for indicating a specific position in the image. Further, the annotational data element may illustrate a specific structure such as a line, curve in order to indicate a course or development of a structure (of “something”) within the image.

The annotational data element may also comprise an indication for an area, such as a geometrical object like a circle, rectangle or a freehand marked area which may be used in order to a specific region within the medical image. Further, an annotational data element may be, for example, a text box or any other element for providing (additional) text in order to add an explanation or comment to a specific position within the medical image. However, the annotational data element is not limited to the above-mentioned examples. Moreover, annotational data elements may be any kind of supplementary element which may be added to the original medical image for providing additional information.

The method comprises to determine the at least one annotational data element. This may be executed by generating the annotational data element (online or in realtime, by user interaction) or by receiving or reading-in an already generated annotational data element.

Thus, the annotational data element may be obtained, for example, from an external data source, such as a storage device or the like. For example, the annotational data element may be provided from a local storage device, a network storage or a cloud service. In order to receive the annotational data elements, an annotational module may be communicatively coupled with an external data source for providing the data for the annotational data elements. For example, the data of an annotational data element may be provided and/or generated by additional fields in a DICOM file and/or in a DICOM header providing the related medical image. Additionally or alternatively, it may be also possible to obtain data related to the annotational data element from further data sources. In this case, the data for the annotational data element may be related to a medical image, for example by a unique identifier indicating the relationship between the annotational data element and the medical image. The annotational data element may be provided as overlay element on the medical image.

When using a medical image which is overlaid with annotational data elements, a user may particularly focus on a specific region within the medical image. In one or more example embodiments, such a specific region within the medical image is named as region of interest. In particular, the region of interest may be a specific region or a part of the image which is considered to be particularly relevant. For example, such a region of interest may be region which is to be analysed or documented by a user. Accordingly, the user may wish to recognise as many details as possible in this region of interest. It is for this purpose that the region of interest should comprise as less annotational data elements as possible in order to minimise the visual obstruction due to annotational data elements. A region of interest may be a specific region within the medical image on which a user currently focuses on. Such a region of interest may be determined by monitoring the input and operation of the user. For example, a region of interest in the medical image may be determined algorithmically, for example, based on a pointer which is controlled by the user. Such a pointer may be, for example, a mouse pointer of a computer mouse, a touch signal of a touchscreen or an indication obtained via eye tracking of the user. However, any other indication which may provide information with regard to the operation or interaction of user may be possible, too. Alternatively, a user may manually specify a region in the medical image as a desired region of interest. For this purpose, the user may perform a freehand drawing of the region of interest or use geometric elements such as circle, rectangle, polygon or the like in order to indicate a specific region which shall be considered as a region of interest. Alternatively, or additionally it may be also possible to automatically identify a region of interest by analysing the content of an image. For example, a segmentation algorithm be performed in order to identify specific elements such as organ, lesion, tumours, blood vessels, bones, implants or the like within the medical image. Since such a segmentation only relates to the identifying of specific regions within the medical image in order to identify a region of interest, the segmentation for this purpose may be performed with a lower resolution, in particular a resolution which is significantly lower than a resolution usually used for diagnostic purposes. Based on this analysis, a specific region of interest may be automatically selected. In case that multiple options for regions of interest may be identified, a menu may be provided to users and the user may select one or more options of identified regions which will be considered as regions of interest in the further proceeding.

In order to minimise the obstructing impact of annotational data elements in the medical image, an appearance of an annotational data element may be adapted. In this context, the expression experience may comprise features such as a position of an annotational data element and/or visual effects applied to the respective annotational data element. In this context, the position of an annotational data element may be considered as the position of the annotational data element within the whole area which can be used for outputting the medical image and the annotational data element. In case that the medical image does not cover the entire area that is available for outputting, an area outside the medical image may be used for outputting an annotational data element. Such an area outside the medical image may be, for example above the medical image, below the medical image or on the left or right side of the medical image. Further to this, it may be also possible to arrange an annotational data element within the medical image but outside a region of interest. Alternatively, it may be also possible that an annotational data element may be arranged at a position so that (only) a part of the annotational data element covers the region of interest.

In case that a specific position is indicated in the original data specifying an annotational data element, such an originally specified position may be considered as initial position. In this case, the initial position may be used as position for arranging the respective annotational data element if the annotational data element does not cover the region of interest. However, if an annotational data element with an initial position partially or completely covers the region of interest, it may be possible to change the position of this annotational data element. In this way, a modified position, i.e. a target position may be determined. Especially, the target position may be a position so that the annotational data element does not or at least only partially covers the region of interest.

The appearance of an annotational data element may further comprise any kind of feature in connection with visual effects. For example, the appearance of an annotational data element may also relate to a size of the annotational data element with which the annotational data element is provided in common with the medical image. The size of an annotational data element may be an extension in horizontal and/or vertical dimension of the whole annotational data element. The size of the annotational data element may be changed by scaling the extension of the annotational data element. In case that the annotational data element comprises text, it may be also possible to reduce the font size in order to minimise the extensions of the annotational data element. Further it may be also possible to use a spacing between lines, words or characters in order to modify the size of the whole annotational data element. Further it may be also possible to change a font style, use acronyms, abbreviations, adapt text wrapping or perform any other approach in order to reduce the size of an annotational data element. The appearance of an annotational data element may also relate to a style of the visual representation. For example, a solid representation of an annotational data element may be changed to a representation using only lines, in particular lines for indicating a border, contour or a specific structure, using of dashed dotted lines instead of solid lines, applying a shadowing or shading and/or modifying a transparency level of the annotational data element. The above-mentioned possibilities for modifying the appearance of an annotational data element, in particular the position and/or visual effects may be combined. Further, these are only examples and do not limit the present invention. Moreover, any other kind of modification for the appearance of an annotational data element may be possible, too.

In order to output the resulting representation, in particular the medical image in combination with the one or more annotational data elements to a user, the annotational data elements may be output in common with the related medical image. For this purpose, the individual components, i.e. the medical image and the annotational data elements according to the applied appearance may be output. This output may comprise outputting the medical image and the one or more annotational data elements according to the computed appearance on an appropriate output device. For this purpose, an appropriate output device such as a display, e.g. a monitor or a computer display, or any other appropriate output device may be provided with the medical image and the annotational data elements according to the computed appearance via an output interface. This output interface may be, for example, a data interface which is communicatively coupled with the output device. For example, the output interface may be a rendering device which renders the medical image and the annotational data elements according to the computed appearance in order to a present and output the result of this rendering process to the output device. For example, the output interface may generate a graphical signal which is provided to a screen or monitor via a graphical interface such as HDMI or display port.

In order to receive user interaction such as an indication of the user for specifying a current position, determining a region of interest and/or entering further (e.g. textual) commands, an appropriate input device may be communicatively coupled with an input interface for receiving the user interaction. For example, this input interface may receive signals from a computer mouse in order to detect a current position which is intended by the user. Alternatively, user may specify a specific position via a touch on a touch screen. A position on which a user focuses may be also determined, for example, by a device for tracking the eyes of the user. Accordingly, such a device may provide an indication for specifying a position on which the user currently looks. Further, it may be possible that a user may enter any kind of text via a keyboard or a voice recognition system. In this way, the user may enter text, which can be used, for example, for a report or documentation of the medical image. In this case, the entered text may be monitored in order to perform a semantic analysis. Based on this semantic analysis, further operations, such as a determination of a region of interest or a change of a previously determined region of interest to another region of interest may be triggered. Additionally or alternatively, the user may enter any kind of commands in order to initiate an appropriate processing, for example a selection of a specific region of interest, a triggering for an automated segmentation of the medical image, a change of a prospective, assuming operation, etc.

In a possible embodiment, the at least one annotational data element is first displayed at an initial position in common with the medical image. The step of calculating the appearance of the annotational data element may comprise adapting the initial position to a target position. In this way, an initial position, i.e. an initially intended or automatically pre-det position may be assigned to an annotational data element, and this initial position may be used if appropriate. Further, the initial position may be changed to another appropriate position, i.e. the target position, if the initial position is in conflict with the region of interest. In this way, visual impairments due to the annotational data element can be avoided or at least reduced.

In a possible embodiment, after the step of determining the at least one annotational data element and before determining the region of interest the method may further comprise a step of displaying the medical image for the purpose of determining the region of interest. After displaying the medical image, a manual or automated approach for identifying a region of interest in the displayed medical image can be performed. In this way, the region of interest can be easily adjusted to the actual displayed medical image.

In a possible embodiment, the determining of the region of interest may be based on user interaction with the displayed medical image. In particular, the determining of the region of interest may be based on monitoring a pointer position, an eye-tracking of a user and/or a semantic analysis of the displayed medical image. Additionally or alternatively determining the region of interest may comprise executing a segmentation algorithm in order to identify an area of a body, a predetermined part of the body or an organ or a structure within the displayed medical image. In this way, an automated determination of an appropriate region of interest in the displayed medical image can be achieved.

In a possible embodiment, the calculating of the appearance may comprise calculating a position for outputting the at least one annotational data element in relation to the medical image. In particular, the appearance may be calculated based on a spatial distance between an initial position of the at least one annotational data element and the determined region of interest. Additionally or alternatively, the appearance may be calculated so that the at least one annotational data element is not or only slightly overlapping the determined region of interest. “Slightly” in this respect may be defined as a percentage of overlapping. E.g. it may be pre-configured that the percentage of allowed overlapping is in the range of 10% to 50%, in particular 20% to 40% and more particular 30% of the region of interest. In this way, an appropriate position for annotational data element may be chosen so that the region of interest in the medical image is affected as less as possible. The overlapping percentage may be configured before or even during the step of calculating the appearance.

In a possible embodiment, the step of calculating the appearance may comprise adapting a size of the at least one annotational data element. In particular, the appearance may be calculated by adapting a font size of a text, replacing an expression by an abbreviation, adapting text wrapping, adapting a transparency level of the at least one annotational data element, displaying only outlines or contours of the at least one annotational data element, substituting the at least one annotational data element by a thumbnail and/or applying shading, shadowing and/or dashed graphical structures. Accordingly, the impairment of an additional data element can be reduced by applying an appropriate visual effect so that the details in the region of interest of the medical image can be recognised in the best possible way.

In a possible embodiment, the calculating of an appearance of the at least one annotational data element may comprise determining an output area for displaying the at least one annotational data element. In this case, the output area may be an area outside the medical image and/or an area outside an area representing a body or a part of a body in die medical image and/or an area outside the determined region of interest. By identifying such an appropriate output area for displaying annotational data element, a simple concept for providing annotational data element in an appropriate area which does not affect the region of interest can be achieved.

In a possible embodiment, the outputting of the calculated appearance of the at least one annotational data element in common with the medical image may be based on predetermined properties for the at least one annotational data element and/or predetermined properties of the medical image. A property may be any kind of feature related to an annotational data element. For example, a property may relate to a visual appearance of an annotational data element, e.g. a size of the annotational data element required for outputting the annotational data element. Further, the property may relate to a specific kind of information of an annotational data element, e.g. a label specifying a particular element within the medical image. However, any other kind of property may be possible, too. In this way, the appearance of an annotational data element may be adapted in a different manner depending on the degree of importance or any other specific feature according to the respective property of the annotational element.

In a possible embodiment, the step of calculating the appearance may comprise determining a ranking for multiple annotational data elements. In this case, the calculating of the appearance of the data elements may be performed based on the determined ranking. Accordingly, annotational data elements having a higher ranking such as a priority or a higher level of relevance, may be provided with an appearance which can be better recognised, while an appearance of annotational data elements with a lower ranking may be adapted in such a manner that these annotational data elements may have less impact with regard to the region of interest.

In a possible embodiment, the medical image may be received from an imaging device, such as an ultrasonic imaging modality. Additionally or alternatively, the medical image may be received from an X-ray modality. In particular, the medical image may be received from a computer tomograph, from a positron emission tomography apparatus and/or from a magnetic resonance tomograph. However, any other kind of device for capturing images in connection with medical purposes may be possible, too.

In a possible embodiment, the at least one annotational data element may comprise a graphical, textual and/or numerical element. Additionally or alternatively, the at least one annotational data element may comprise metadata relating to a patient, a configuration of a medical imaging modality for capturing the medical image and/or data specifying a date and/or data relating to a purpose for capturing the medical image. Further to this, any other kind of information which may relate to the medical image, may be possible too. In this way, the annotational data elements may provide important information for manually or automatically (via software applications) analysing and understanding the medical image.

In a possible embodiment, the at least one annotational data element may be determined based on metadata and/or supplementary data provided in association with the medical image. For example, the annotational data element may be determined from information provided in additional data fields of a dataset comprising the image data of a medical image. For example, a header of a medical image may comprise additional information which can be used for deriving at least one annotational data element.

In a possible embodiment, the appearance of an annotation data element is adapted in reply to a zoom level of the medical image. In this way, the appearance of the at least one annotational data element may be dynamically adapted according to a current zoom level which is used for displaying the medical image. For example, if a zoom level of medical image increases, the area relating to the region of interest may also increase, and thus, the appearance of the annotational data elements may be adapted such that the increased area of the region of interest may be not affected by annotational data elements.

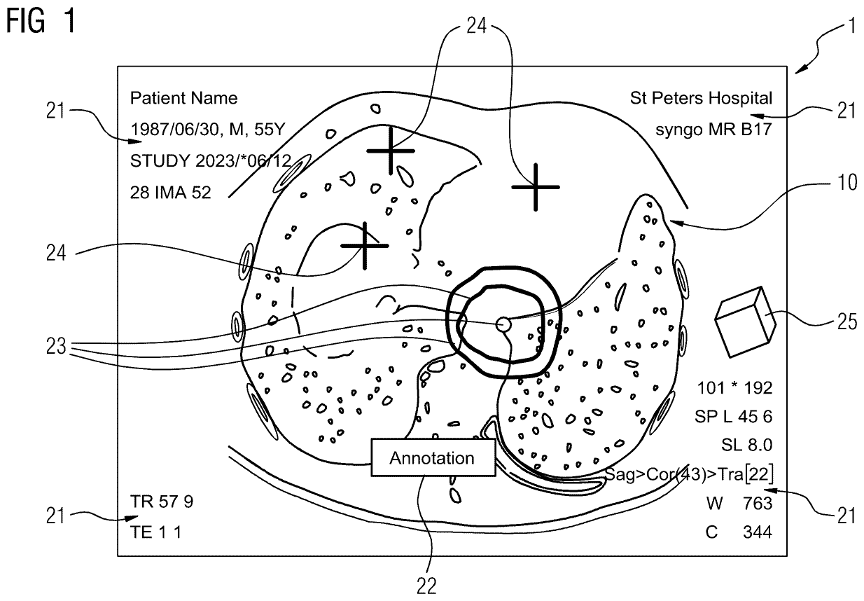

FIG. 1 shows a schematic illustration a representation 1 of a medical image 10 together with multiple annotational data elements 21-25.

The medical image 10 may be a two-dimensional image which has been captured for medical purposes. The medical image 10 may be an image of a body or at least a part of the body of a human being or an animal. The medical image 10 may be received, for example, by an ultrasonic image modality or an X-ray modality, a computer tomograph, a positron emission tomography apparatus or a magnetic resonance tomograph. However, any other device for acquiring medical images may be possible, too. The data of the medical image 10 may be captured in a two-dimensional or three-dimensional space, and based on the captured data, a two-dimensional image may be provided as medical image 10.

As can be further seen in FIG. 1, the representation 1 may comprise one or more annotational data elements 21-25. The annotational data elements 21-25 may be any kind of additional element (in addition to the image as such) in the representation 1 for providing additional information and/or indicating a particular position or region. The annotational data element 21-25 may comprise a graphical, textual and/or numerical element. Further, the annotational data element 21-25 may comprise a configuration of a medical imaging modality which has been used for acquiring or capturing the medical image, data specifying a date or further data relating to purposes for capturing the medical image 10 (e.g. a medical question). For example, the annotational data elements 21-25 may comprise a text element 21 for providing additional text. In this way, additional information such as information with regard to a patient, a desired purpose for capturing the medical image, a location and/or a configuration of the device used for recording the medical image, or any other kind of information may be provided. Further, the annotational data elements 21-25 may comprise boxes 22, for example text boxes, including additional information, in particular annotational text. The annotational data elements 21-25 may also comprise graphical elements 23 which may be used, for example, for indicating a particular region within the medical image. The graphical elements 23 may be graphical elements which are generated manually by a user and/or graphical elements which are automatically generated, for example, based on a processing of the medical image 10. For instance, a segmentation may be applied to the medical image 10 in order to identify a specific area such as an organ, a lesion, a tumour or a certain structure such as an implant or a stent. The annotational data elements 21-25 may also comprise one or more markers 24 which may be used for indicating a specific position within the medical image 10. Further, any other kind of annotational data element may be used, such as graphical elements 25, which may be used, for instance, for illustrating an orientation of the two-dimensional medical image 10 with in the three-dimensional space. The above-described list of annotational data elements 21-25 only provides some exemplary possibilities of annotational data elements 21-25. Further to this, any other appropriate kind of annotational data elements 21-25 may be possible, too.

As can be recognised from the illustration provided in FIG. 1, in state of the art it may be possible that due to the numerous annotational data elements 21-25 the details of the medical image 10 may be hidden at least partially. Especially if the user wants to work on a certain area within the medical image 10, the user may assign several annotational data elements 21-25 to this area but at the same time, the user wants to recognize as many details as possible of this area. Therefore, a complete hiding of the annotational data elements 21-25 for such tasks is not appropriate. In view of this, according to the present disclosure, a dynamic modification of an appearance of the annotational data elements 21-25 is provided.

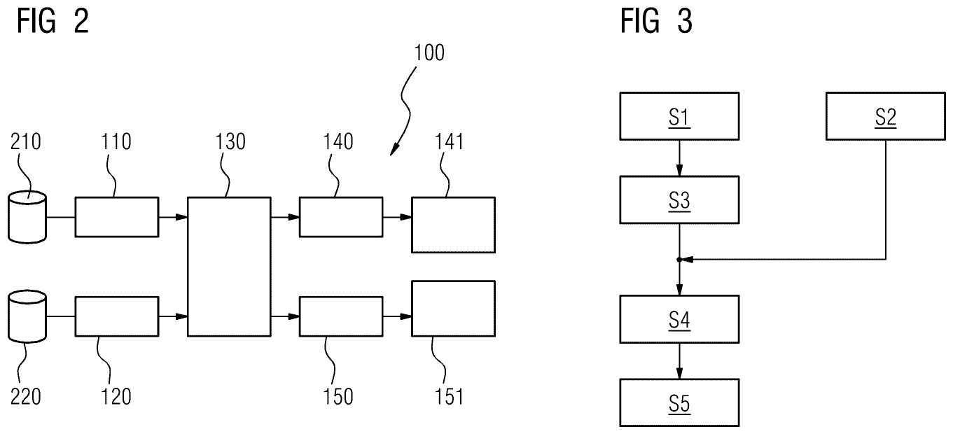

FIG. 2 shows a schematic block diagram of an apparatus 100 for processing a medical image 10. The apparatus 100 may comprise a reception interface 110, an annotational unit 120, a processing unit 130 and an output interface 140.

The reception interface 110 may receive data of a medical image 10. The data of the medical image 10 may be received, for example, from a related storage device 210 or directly from the scanner (image acquisition modality). For this purpose, the reception interface 110 may be communicatively coupled with this storage device 210. The data of the medical image 10 may be received in any appropriate format, e.g. according DICIM standard. However, any other image format may be possible, too.

The annotational module 120 may receive data for at least one annotational data element 21-25. The data of the at least one annotational data element 21-25 may be received, for example, from a related further storage device 220. For this purpose, the annotational module 120 may be communicatively coupled with this further storage device 220. Based on the received data, annotational module 120 may further determine at least one annotational a data element 21-25. For example, the annotational module 120 may determine what kind of annotational data element the received data refers to and to which position in the medical image 10 the annotational data element refers to. For example, the annotational module 120 may determine whether the received data refer to text, a graphical element, an indication for a specific position or area, etc. The data for each annotational data element 21-25 may be determined, for example, based on metadata provided in association with the data of the medical image 10. For example, the data of an annotational data element 21-25 may be obtained from data fields in a DICOM header or file. However, it may be also possible to provide the data for annotational data elements 21-25 in any other appropriate manner, for example via separate, additional data files.

The processing unit 130 may perform a processing of the received medical image 10 and the related annotational data elements 21-25. In particular, the processing unit 130 may adapt the appearance of the annotational data elements 21-25 when outputting the annotational data elements 21-25 together with the related medical image 10. In this connection, the term “appearance” may relate to the position where an annotational data element 21-25 is output and the visual effects which are applied to the respective annotational data element 21-25 when outputting the annotational data element 21-25.

It is for this purpose that the data processing unit 130 determines a region of interest in the received medical image 10. Such a region of interest may relate to a specific region within the medical image 10. For example, the region of interest may be a position of an area on which a user is currently focusing. For example, if the user is currently focusing on a particular organ or a specific section of an organ, e.g. a lesion or a tumour, processing unit 130 may automatically identify this region as region of interest.

For automatically identifying such a region of interest, the processing unit 130 may apply any appropriate approach. For example, monitoring of a pointer, e.g. the movement of a computer mouse, eye-tracking, a semantic analysis of text entered by the user or the like may be applied in order to identify such a region of interest. Furthermore, it may be also possible to perform an automated analysis of the medical image 10, e.g. perform a semantic analysis and/or a segmentation, in order to identify a specific region which may be considered as region of interest. Since the result of such a segmentation is only used for identifying a specific region of interest, the segmentation may be based on a reduced resolution of the medical image. In this way, the segmentation may be performed much faster and with less computational requirements. However, any other appropriate approach for determining a region of interest may be possible, too.

After determining a region of interest, the processing unit 130 may further calculate an appropriate appearance for each annotational data element 21-25 which shall be provided in association with the related medical image 10. In particular, the appearance of the annotational data elements 21-25 may be adapted such that the user can recognise that the region of interest is as unobstructed as possible. For example, a position for an annotational data element 21-25 may be chosen such that the annotational data element 21-25 is output outside the determined region of interest.

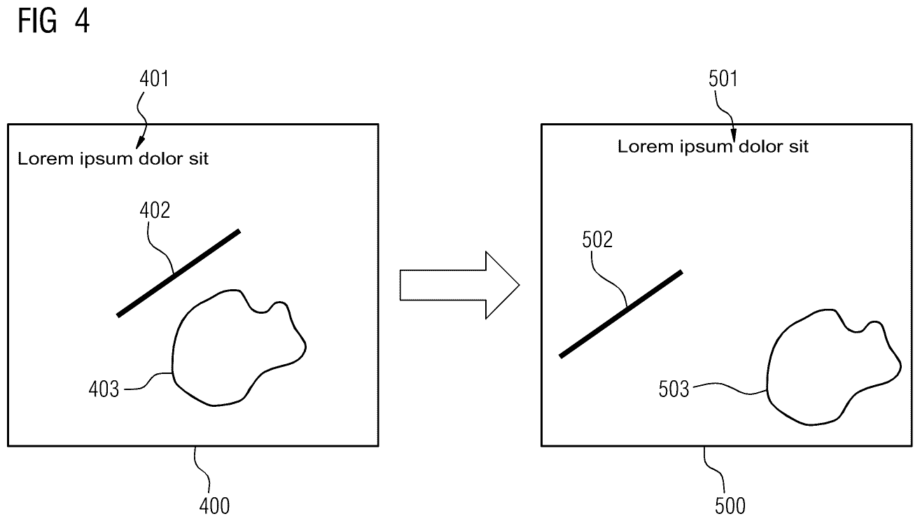

Additionally or alternatively, it is also possible to adapt the representation of an annotational data element 21-25 in reply to the determined region of interest. For example, a transparency level of the annotational data element 21-25 may be adapted or set automatically, the size of the annotational data element 21-25 the text size of text comprised by the annotational data element 21-25 may be reduced and/or any other appropriate modification may be applied. More possibilities for adapting the appearance of an annotational data element 21-25 will be described below, e.g. in connection with FIGS. 4-9.

After having calculated an appropriate appearance for each of the annotational data elements 21-25 which shall be provided together with the related medical image 10 by the processing unit 130, the calculated appearances of the annotational data elements 21-25 are output in common with the related medical image 10 by output interface 140. For this purpose, the medical image 10 and the annotational data elements with the calculated appearances may be transmitted to an output device 141 via output interface 140. The transmitted medical image 10 and the related annotational data elements 21-25 may be output by the output device 140. For example, the output device 140 may display the medical image 10 and the related annotational data elements 21-25 on a computer screen.

Further, the apparatus 1 may comprise an input interface 150 for receiving user interaction. The user interaction may be received, for example, via a computer mouse, a device for eye tracking of the user, a touch screen, a keyboard, a system for voice recognition or any other appropriate device for receiving user input. In case that such user interaction is received, processing unit 130 may consider this user interaction in order to determine the region of interest. In this way, the region of interest and thereon the appearances of the individual annotational data elements 21-25 may be dynamically adapted in response to the received user interaction.

FIG. 3 shows a block diagram illustrating a method for processing a medical image according to an embodiment. The method may comprise any step that may be appropriate to be performed by the apparatus 100 as described above. Likewise, the previously described apparatus 100 may comprise components that may be appropriate for performing the method as described below.

In a step S1, the medical image and optionally data for processing the medical image 10 may be received.

In step S2, at least one annotational data element 21-25 may be determined. The at least one annotational data element 21-25 may be determined, for example, based on supplementary data related to the medical image 10. For example, the supplementary data may be obtained from data fields of a DICOM file (e.g. DIMCOM header) providing the data of the medical image 10. However, any other appropriate manner for providing data for annotational data elements 21-25 may be also possible. For example, the data may be provided by an additional data file related to the medical image 10.

In step S3, a region of interest in the received medical image may be determined. The determination may be performed as already described above in connection with the apparatus 100. For example, the region of interest may be determined based on an automatic image analysis of the medical image and/or a user interaction such as monitoring the movement of a pointer, eye tracking, semantic analysis of user input, a segmentation of the medical image or the like.

In step S4, an appearance of the annotational data elements 21-25 may be calculated. In particular, the appearances of an annotational data element 21-25 may be determined in reply to the determined region of interest. For example, the appearance of a data element 21-25 may be adapted such that the annotational data element 21-25 obscures the region of interest as less as possible. Further details for adapting the appearance are described in more detail below.

After having calculated the appearance of the annotational data elements 21-25, the calculated appearances of the annotational data elements 21-25 may be output in step S5 in common with the medical image 10 on an output device 141. For this purpose, the medical image 10 and the calculated appearance of the annotational data elements 21-25 may be transmitted to the output device 141 via an output interface 140.

The appearance of an annotational data element 21-25 may relate to a position where the respective annotational data element 21-25 is output in the representation 1 with the medical image 10, and/or the appearance may relate to visual effects applied to the annotational data element 21-25 when outputting the annotational data element 21-25.

In order to compute an appropriate position for an annotational data element 21-25, it may be possible to determine a (target) position where the respective annotational data element 21-25 does not obscure a region of interest or does obscure it as less as possible.

In a possible embodiment, an annotational data element 21-25 may be displayed first at an initial position. This initial position may be a position where the annotational data element 21-25 is displayed without considering a region of interest. When a region of interest is determined, it is desirable that the annotational data element 21-25 should obscure the region of interest as less as possible. For this purpose, the initial position of the annotational data element 21-25 may be changed. In particular the position of the annotational data element 21-25 may be changed to a target position. The target position may be a position away from the region of interest. In this way, it is possible that the annotational data element 21-25 does not or only at least partially cover the region of interest.

The position for outputting an annotational data element 21-25 may be also adapted based on further rules, which may be stored in a rule base. For example, a position of the annotational data element 21-25 may be adapted based on a spatial distance between the initial position of the annotational data element 21-25 and the region of interest. In case that the initial position of an annotational data element 21-25 is far away from the region of interest, the initial position of this annotational data element 21-25 may be kept unchanged or may be changed only slightly. The closer the annotational data element 21-25 is to the region of interest, the more the position of the respective annotational data element 21-25 may be changed, in particular moved away from the region of interest. In particular, it is desirable that the annotational data elements 21-25 do not or only slightly overlap the region of interest.

Further to determining an appropriate position when calculating the appearance of an annotational data element 21-25, it is also possible to apply appropriate visual effects to the annotational data element 21-25. For example, the appearance of an annotational data element may be adapted by changing a total size of the respective annotational data element 21-25. For this purpose, a scaling of an annotational data element 21-25 may be applied. In case that the annotational data element 21-25 may comprise text, it may be also possible to adapt the text size, to change the font used for the text, to replace at least some expressions by acronyms, adapt a text wrapping or apply any other kind of appropriate modifications. Further, it may be also possible to replace the original annotational data element 21-25 by an appropriate icon or thumbnail. In this way, the size of an area which is required for providing the respective annotational data element 21-25 in the representation 1 with the medical image can be reduced.

Additionally or alternatively, it may be also possible to apply further visual effects which may reduce the obstruction of the visibility of the region of interest in the medical image 10. For example, a transparency level of the annotational data element 21-25 may be set or adapted. Further, it may be possible to display only outlines or contours of an annotational data element 21-25 in order to improve the visibility of details in the region of interest. It may be also possible to apply a shading or shadowing of annotational data elements 21-25, or to use dashed graphical structures instead of solid lines. However, any other appropriate manner for applying visual effects, in particular visual effects which may improve a visibility of the region of interest may be possible, too.

In case that multiple annotational data elements 21-25 shall be provided together with a medical image, a ranking of the individual annotational data element 21-25 may be determined. This ranking may be used for prioritisation of some elements over other elements. For example, annotational data elements 21-25 with a higher priority may be kept within the region of interest or may be positioned close to the region of interest, while annotational data elements 21-25 having a lower priority may be positioned further away from the region of interest. It may be also possible to apply different visual effects to the annotational data elements 21-25 depending on this ranking or prioritisation. For example, an annotational data element 21-25 with higher priority may be represented with a larger size, less transparency, more details, etc. while an annotational data element 21-25 with lower priority may be displayed with smaller size, higher transparency level, less details or by an icon or thumbnail, etc.

The ranking may be already determined in advance and provided in association with the respective annotational data elements 21-25. Further, it may be also possible to determine a ranking by analysing the annotational data elements 21-25 which shall be output. For this purpose, any kind of appropriate analysis, for example a semantic analysis, may be applied. In this way, an automated determination for a ranking or prioritisation can be performed. Alternatively, a fixed, predetermined ranking may be applied.

Furthermore, it may be also possible to perform an analysis of the medical image 10 and/or the annotational data elements 21-25 which shall be provided together with the medical image 10 in order to determine an appearance for the respective annotational data elements 21-25. For example, the annotational data element 21-25 may be analysed in order to identify one or more predetermined properties. In this case, an annotational data element 21-25 relating to such an identified property may be provided at or close to an initial position. Additionally or alternatively, such an annotational data element 21-25 may be displayed with visual effects allowing a better (e.g. faster) processing or good recognition, e.g. larger size, lower transparency, solid lines etc. Other annotational data elements 21-25 on the other hand may be displayed at positions further away from the region of interest and/or by applying visual effects which reduce visual obstruction by such annotational data elements 21-25.

In order to easily find appropriate positions for an annotational data element 21-25, it may be possible to determine an appropriate output area for displaying such an annotational data element 21-25. For example, if the medical image 10 in the representation 1 does not cover the complete area which is available in the representation 1, the output area for providing at least some of the annotational data elements 21-25, may be selected to an output area outside the medical image 10.

Additionally or alternatively, it may be also possible to perform an automatic image analysis of the medical image 10. Based on this analysis, it may be possible to identify regions in the medical image 10 which relate to a body, a part of the body, a specific organ or structure which is considered to be particularly relevant for the image processing or the medical question. Hence, in this case the output area may be selected to an area outside this relevant region. For example, if a medical image comprises a region showing a part of the body (e.g. a certain bone) and further one or more less relevant regions surrounding this part of the body, e.g. by air or tissue. In this case, the surrounding areas (air or tissue or structures of less relevance) may be selected as an appropriate output area. In such a case, at least some of the annotational data elements 21-25, may be located at positions within this output area.

The calculation of an appearances for an annotational data element 21-25, may be performed once when generating a representation 1 with a medical image 10 and one or more annotational data elements 21-25. Further, it may be possible to dynamically adapt the representation and in particular the appearance of the annotational data elements 21-25 during operation. For example, the appearance of an annotational data element 21-25, may be adapted in response to a user interaction. For instance, it may be possible to monitor the user interaction in order to dynamically adapt the region of interest. In response to this, the appearance of annotational data elements 21-25, may be adapted when the region of interest changes.

For example, the region of interest may be determined by monitoring a pointer such as a mouse icon of a computer mouse, receiving a touch on a touch screen, and eye tracking of the user for identifying the position where the user is looking at or the like.

It may be also possible to adapt the appearance of the annotational data elements 21-25 when a zoom level of the medical image 10 is changed.

Furthermore, it may be also possible to analyse a user input, for example a text, in particular a text relating to documentation of the medical image. Such a text may be input, for example by a keyboard or a voice recognition system. In this case, a semantic analysis of the text may be performed, for example to identify keywords. Based on this analysis of the text, it may be possible to identify a specific region in the medical image 10 which is currently considered by the user. Based on this, the region of interest may be adapted accordingly. For example, if a user enters “The image shows tumour cells in the liver . . . ”, it may be possible to automatically identify such tumour cells in the medical image 10 and to determine the region of interest to this tumour cells. If the user further enters “the right border of the liver . . . ”, the region of interest may be changed to the right border of the liver illustrated in the medical image 10.

When identifying a specific position in the medical image 10 on which the user currently focuses, the region of interest may be determined based on this position. For example, the region of interest may be determined to a region having a predetermined distance to this position on which the user currently focuses. Alternatively, the image data of the medical image 10 may be analysed in order to identify specific structures relating to the position on which the user currently focuses. For example, a segmentation of the medical image 10 may be performed and a region of interest may be selected as an element at or nearby a position on the user currently focuses. For example, if the user focuses on a specific blood vessel, for example because a pointer controlled by a user moves over this blood vessel, the respective blood vessel may be automatically selected as a region of interest. When the user changes his or her focus, the region of interest may be automatically changed, and thus, the appearance of the annotational data elements 21-25 may be also changed in response to the changed region of interest.

In a preferred embodiment, thus, the region of interest is determined dynamically, in particular, iteratively.

Further, it may be also possible that a user may manually identify a specific region of interest. For example, a user may select a specific position. This may be performed, for instance by a touch or a mouse click. The user may also manually indicate a desired region of interest by any other appropriate interaction, e.g. by drawing a circle, a rectangle, a polygon or a free hand drawing. Alternatively, the specific may be determined based on a semantic analysis of text input by the user. After such a process of identifying the region of interest, the focus of the user may be monitored, for example by monitoring a mouse pointer or tracking the eye movement. Based on this monitoring of the user's focus, the appearance of an annotational data element 21-25 may be changed in reply to the distance between the user's focus and region of interest.

The change of the appearance, in particular the change in the visual effects may be performed, for example, by toggling between a predetermined number of visual effects. For example, the transparency may be changed between two or more different transparency levels, the size may be changed between a larger size and a smaller size, a graphical representation may be changed between the original representation and a thumbnail representation, etc. Alternative to a switching between only two or a smaller number of different effects, it may be also possible that the appearance of annotational data element 21-25 may be changed dynamically in response to a pointer or a position on which the user currently focuses and a (preselected) region of interest. For example, an appearance, in particular a visual effect of an annotational data element 21-25 may be gradually or continuously changed based on a distance between the region of interest and the position on which the user currently focuses.

In the following some examples for adapting the appearance of annotational data elements 21-25 are described. The described modifications of the appearance may be applied individually or in combination. For example, different modifications for adapting the appearance of an annotational data element 21-25 may be applied to different annotational data elements 21-25. Furthermore, it may be also possible to apply multiple of the described examples for adapting the appearance in combination to an annotational data element 21-25. Furthermore, it should be noted that the described possibilities for adapting the appearance are only some examples which do not limit the scope of the present invention. Moreover, any other kind of appropriate approach for adapting the appearance of annotational data elements 21-25 may be possible, too.

In the following, reference sign 400 relates to a representation comprising annotational data elements 401-403 with an initial appearance, i.e. an initial position and/or visual effects as originally desired without considering the region of interest. Further, reference sign 500 relates to a representation with further amendments applied to the appearance of the annotational data elements so that the annotational data elements are provided with an amended/adjusted appearance as annotational data elements 501-503.

For sake of better clarity, in the following examples only the annotational data elements 401-403 and 501-503 are shown, wherein the related medical image has been omitted.

FIG. 4 shows on the left-hand side an exemplary representation 400 of three annotational data elements 401-403. In this example, a first annotational data element 401 relates to a text, second annotational data element 402 relates to a line, and third data element 403 relates to a graphical element, e.g. indicating an object.

As can be seen on the right-hand side of FIG. 4, the positions of the annotational data elements 501-503 may be changed. In this way, the annotational data elements 501-503 may be located at positions such that a region of interest in the medical image (which is not shown) can be recognised without or at least with less interference is due to obstacles caused by the annotational data elements.

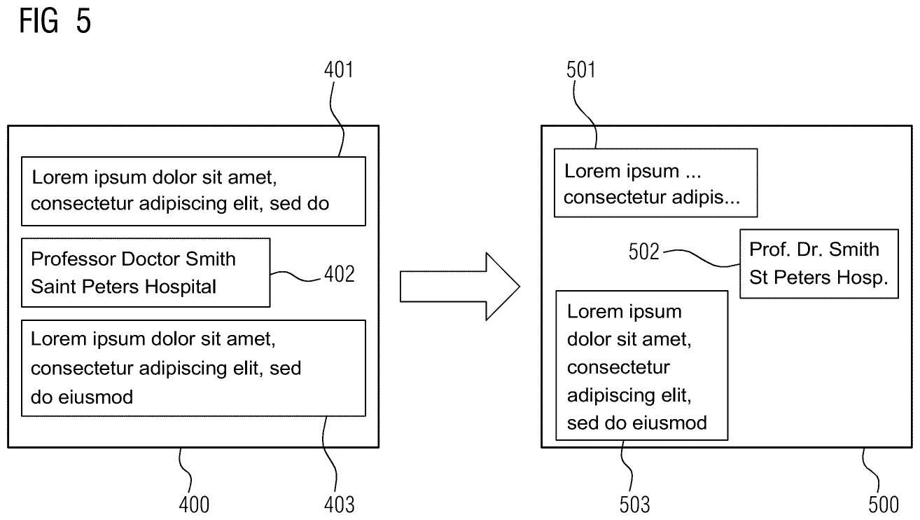

FIG. 5 shows a further example of a representation 400 with three annotational data elements 401-403, wherein the annotational data elements 401-403 on the left are provided as text elements with full text. As illustrated on the right side of FIG. 5, a size of the respective annotational data elements can be reduced by shortening the text or applying an amended text wrapping. For example, the text in the first annotational data element 501 has been shortened by providing only the beginning of the text followed by three dots. In the second annotational data element 502 of FIG. 5 the original full text has been shortened by using acronyms. Further, in the third annotational data element 503, the text wrapping has been changed so that a width of the respective text box is reduced, whereby the height of the text box is increased.

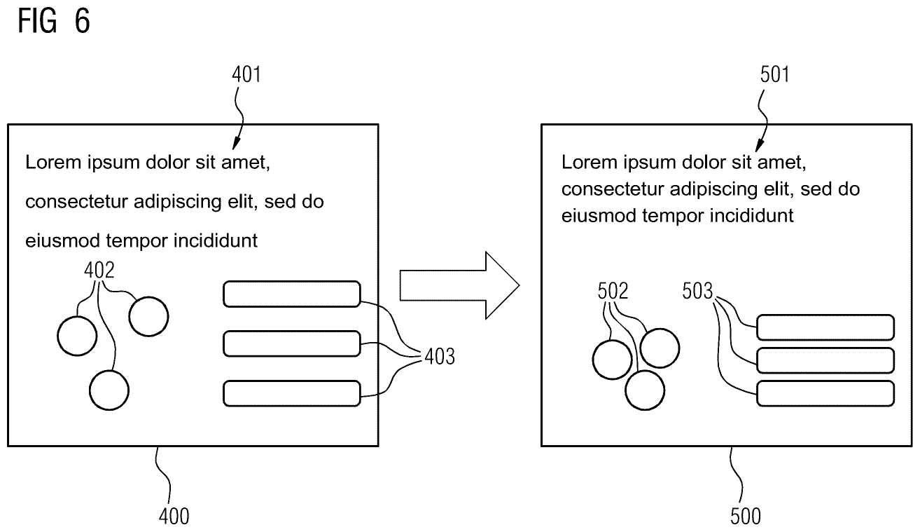

FIG. 6 shows a further example for adapting the appearance of annotational data elements 401-403 in a representation 400. In this case, a distance between individual elements of an annotational data element 401-403 is reduced. For example, a line spacing between individual lines of a text has been reduced in the annotational data element 501. Similarly, it is also possible to reduce a spacing between the individual letters or words of the text, use a different font style or perform further similar operations. In the second annotational data element 502, the spacing between the individual elements (circles) has been reduced in horizontal and vertical dimension. In the third annotational data element 503 of this example, the spacing has been only reduced in vertical direction, while no amendment has been applied in horizontal direction. Is clear, that similar operations may be performed by changing only the spacing in horizontal direction.

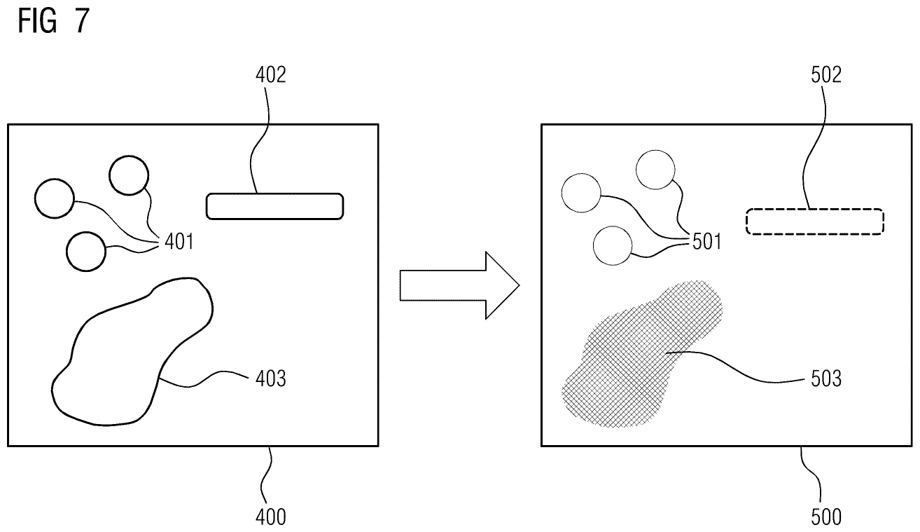

FIG. 7 shows further exemplary possibilities for adapting the appearance of annotational data elements 401-403. As can be seen on the right-hand side of FIG. 7, the appearance of the first annotational data element 501 has been changed by displaying only an outer border of the individual elements. Depending on the respective data element, it also may be possible to show further details of the annotational data element 501 by some inner lines within the respective annotational data element. The appearance of the second annotational data element 502 has been changed by displaying the respective annotational data element 402 only by dashed lines. It is clear, that instead of dashed lines, any other approach for an amended line style, for example dotted lines or the like may be possible, too. The appearance of the third annotational data elements 503 has been changed by displaying the respective annotational data element 503 by a shaded illustration. For this purpose, any kind of shading may be possible. Similar to shading it may be also possible to apply a shadowing of any similar modification of the appearance. Even though not explicitly illustrated in this figure, it may be also possible to change a transparency level of an annotational data element.

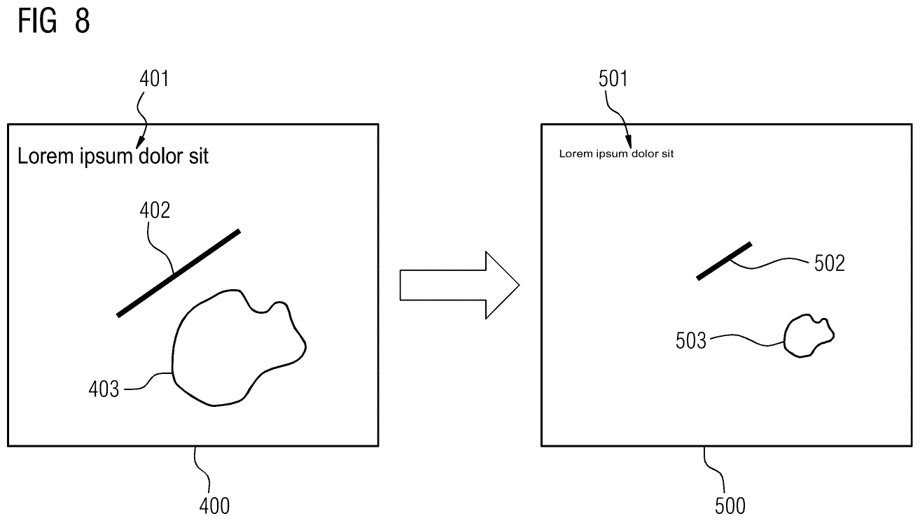

FIG. 8 shows a still a further exemplary possibility for adapting the appearance of annotational data elements 401-403. As can be seen in the right-hand side of this figure, the size of the individual annotational data elements 501-503 may be changed, in particular reduced. For example, the text size of the text in annotational data element 501 may be reduced. In a similar manner, the length of the line in annotational data element 502 is shortened and the size of the third annotational data element 503 is reduced. Instead of simply reducing the size of annotational data element 501-503, it may be also possible to replace the original annotational data element by a minimised illustration such as an icon or a thumbnail.

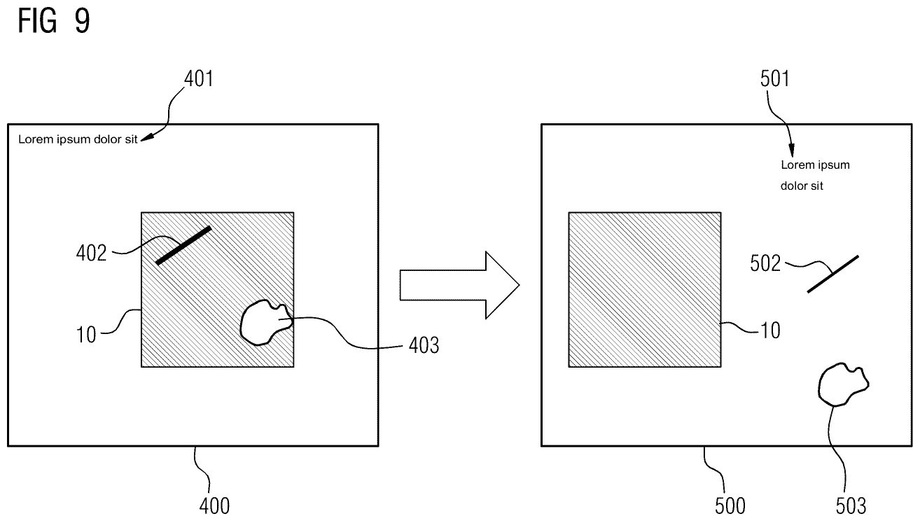

FIG. 9 finally shows still a further possibility for adapting the appearance of annotational data elements 401-403. In this example, the annotational data elements are removed from the initial position to a completely different area of the representation 500. In particular, the annotational data elements 501-503 may be arranged at an output area outside the medical image 10.

Summarising, one or more example embodiments relates to a processing of medical images when a medical image is provided together with at least one annotational data element. It is proposed to identify a specific region of interest, which is currently relevant for a user. After identifying such a region of interest, which may be done dynamically or continuously, the at least one annotational data element is provided with an appearance so that the region of interest is obscured as less as possible.

To the extent not already explicitly described, individual embodiments or individual aspects and/or features thereof described with reference to the drawings may be combined or interchanged with one another without limiting or expanding the scope of one or more example embodiments described, where such combination or interchange is useful and within the spirit of the present invention. Advantages described with respect to a particular embodiment of the present invention or with respect to a particular figure are, wherever applicable, also advantages of other embodiments of the present invention.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. Example embodiments may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

1. A method for processing a medical image, the method comprising:
receiving the medical image;
determining at least one annotational data element to be displayed in common with the received medical image, the at least one annotational data element being related to the received medical image or parts of the received medical image;
determining a region of interest in the received medical image;
calculating an appearance of the at least one annotational data element in reply to the determined region of interest; and
outputting the calculated appearance of the at least one annotational data element in common with the received medical image by an output device.

2. The method of claim 1, wherein the at least one annotational data element is first displayed at an initial position in common with the received medical image and the calculating includes adapting the initial position to a target position.

3. The method of claim 1, further comprising:
displaying the received medical image after the determining the at least one annotational data element and before the determining the region of interest the method.

4. The method of claim 3, wherein the determining the region of interest is based on a user interaction with the displayed medical image.

5. The method of claim 1, wherein the calculating includes,
calculating a position for outputting the at least one annotational data element in relation to the received medical image, based on at least one of a spatial distance between an initial position of the at least one annotational data element and the determined region of interest or such that the at least one annotational data element is not or only slightly overlapping the determined region of interest.

6. The method of claim 1, wherein the calculating includes at least one of,
adapting a size of the at least one annotational data element,
replacing an expression by an abbreviation,
adapting text wrapping,
adapting a transparency level of the at least one annotational data element,
displaying only outlines or contours of the at least one annotational data element,
substituting the at least one annotational data element by a thumbnail, or
applying at least one of a shading structure, a shadowing structure or a dashed graphical structure.

7. The method of claim 1, wherein the calculating includes,
determining an output area for displaying the at least one annotational data element, wherein the output area is at least one of an area outside the received medical image, an area outside an area representing a body or a part of a body in the received medical image. or an area outside the determined region of interest.

8. The method of claim 1, wherein the outputting is based on at least one of predetermined properties for the at least one annotational data element or the received medical image.

9. The method of claim 1, wherein the calculating includes,
determining a ranking for multiple annotational data elements, and wherein the calculating is based on the determined ranking.

10. The method of claim 1, wherein the medical image is received from at least one of an ultrasonic imaging modality, an X-ray modality, a positron emission tomography apparatus or a magnetic resonance tomograph.

11. The method of claim 1, wherein the at least one annotational data element comprises at least one of,
at least one graphical element, a textual element or a numerical element,
meta data relating to a patient,
a configuration of a medical imaging modality for capturing the medical image,
data specifying a date, or
data relating to a purpose for capturing the medical image.

12. The method of claim 1, wherein the determining the at least one annotational data element is based on at least one of metadata or supplementary data provided in association with the received medical image.

13. The method of claim 1, wherein the appearance of an annotation data element is adapted in reply to a zoom level of the medical image.

14. An apparatus for processing a medical image, which is configured for executing the method of claim 1, comprising:
a reception interface configured to receive the medical image;
an annotational unit configured to determine the at least one annotational data element;
a processing unit configured to determine the region of interest in the received medical image and calculate the appearance of the at least one annotational data element in reply to the determined region of interest; and
an output interface configured to output the calculated appearance of the at least one annotational data element in common with the medical image.

15. A non-transitory computer readable medium including program code sections, when executed by a computing unit, cause the computer unit to perform the method of claim 1.

16. The method of claim 4, wherein the determining the region of interest is based on at least one of monitoring a pointer position, an eye-tracking of the user, or a semantic analysis of the displayed medical image.

17. The method of claim 3, wherein the determining the region of interest comprises executing a segmentation algorithm to identify an area of a body, a predetermined part of the body or an organ or a structure within the displayed medical image.

18. The method of claim 6, wherein the adapting the size of the at least one annotational data element adapts a font size of a text.
